(19) United States
(12) Patent Application Publication
(10) Pub. No.: US 2002/0031447 A1
(43) Pub. Date: Mar. 14, 2002

(54) Optical sensor having a sensitive layer containing particles

(76) Inventors: Thomas Brinz, Bissingen Unter Der Teck (DE); Heidrun Potthast, Gerlingen (DE)

Correspondence Address: KENYON & KENYON, ONE BROADWAY, NEW YORK, NY, 10004, US

(21) Appl. No.: 09/887,180

(22) Filed: Jun. 22, 2001

(30) Foreign Application Priority Data
Jun. 2, 2001 (DE) 101 27 059.3
Jun. 24, 2000 (DE) 100 30 914.3

(51) Int. Cl. G01N 21/75

(52) U.S. Cl. 422/88; 436/117; 436/113; 436/109; 436/122; 436/119; 436/133; 436/124; 436/164

(57) ABSTRACT

An optical gas sensor for determining a gas in a gas mixture, especially for determining a gas component in the air, is described, having a radiation source and having a sensitive layer positioned on a substrate. The sensitive layer of the sensor is porous and contains particles, which are optically transparent to a radiation emitted by radiation source and which lengthen the optical path of the radiation.

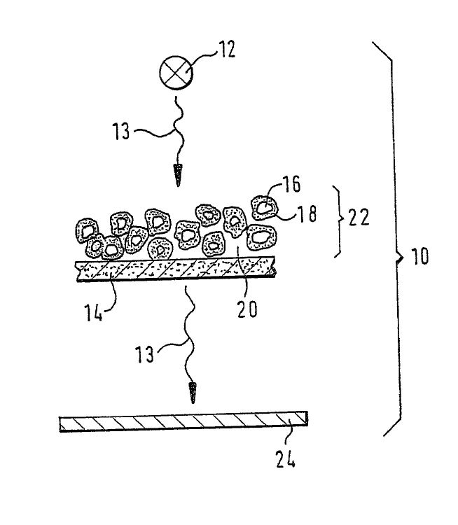

### FIELD OF THE INVENTION

The present invention refers to an optical sensor.

### BACKGROUND INFORMATION

Optical sensors for determining the concentration of a gas, such as the carbon dioxide content of the air, are used, among other things, in fire alarms. Their functioning is based on a layer of the sensor, sensitive to carbon dioxide, reversibly changing color at contact with the gas to be determined. This color change is detected by a detector, and an alarm is tripped when a predefined minimum concentration is exceeded.

Such detectors are subject to the requirement that they detect sufficiently accurately even very low gas concentrations. The greater the layer thickness of the sensitive layer of a sensor, the greater is the light absorption of the sensitive layer, and the more accurate are the measuring results of the sensor. This would make obvious a sensitive layer thickness as great as possible. It is true, though, that the gases to be determined can diffuse into a sensitive layer only superficially in sufficient amounts, so that accurate measurement by a sensor is hardly influenced by a great layer thickness alone.

However, in order nevertheless to achieve a lengthened optical path inside the sensitive layer of a sensor, U.S. Pat. No. 4,557,900 describes an optical sensor having a sensitive layer containing hydrophobic particles. These lead to a longer optical path within the sensitive layer by light refraction and light scattering. The particles are embedded in a massive polymer matrix, which, however, still hinders the diffusing in.

### SUMMARY OF THE INVENTION

It is an object of the present invention to make available an optical sensor for determining a gas in a gas mixture, particularly for the precise determination of the carbon dioxide content of the air, which overcomes the named disadvantages of the related art.

The optical sensor according to the present invention has the advantage that it permits the measurement of the smallest concentration of gas with great accuracy. This is achieved in that the sensitive layer of the sensor contains translucent particles which lead to a lengthening of the optical path within the layer through the effect of light refraction and light scattering. In addition to that, the sensitive layer is designed in porous form, so that sufficient diffusion of the gas to be determined into the layer is guaranteed, even when the layer thickness of the sensitive layer is increased noticeably.

An open pore development of the sensitive layer is particularly advantageous, because access of the gases is thereby further improved. It is especially advantageous if polydimethylsiloxane is used as the base material for the sensitive layer, because it demonstrates very good diffusion properties, above all for carbon dioxide.

### BRIEF DESCRIPTION OF THE DRAWING

The FIGURE shows schematically an exemplary embodiment of the optical sensor according to the present invention.

### DETAILED DESCRIPTION

Optical sensor 10, illustrated in the FIGURE, includes a radiation source 12, which may be, for instance, a light-emitting diode, and a detector 24, which is developed, for instance, as a photodiode. Between radiation source 12 and detector 24 there is positioned a translucent substrate 14, made of glass. Other optically transmitting substances, such as polymethacrylate, can also be used as the material for translucent substrate 14.

On substrate 14 there is a sensitive layer 22 which reversibly changes color when the minimum concentration of the gas to be determined is exceeded. Sensitive layer 22 includes particles 16 which are optically transparent to a radiation 13 emitted from radiation source 12 and can be made, for example, as little glass spheres or as particles of quartz, sapphire, a ceramic such as zirconium dioxide or a polymer such as PMMA, PA, PP or PS. These lead to refraction or scattering of incident radiation 13, as the case may be, particularly when particles 16 are designed as hollow spheres. Particles 16 have a diameter of 3 to 20 μm, and on their surface they have material 18, which is sensitive to the gas to be determined. This material contains a polymer matrix in which the compounds responsible for the sensitivity of the sensor are located, as, for instance, a pH indicator and a base. In a preferred execution of the sensitive layer 22, this matrix is made of polydimethylsiloxane; but other silicones or polymers such as PVC or ethylcellulose are suitable as well.

When polydimethylsiloxane is used as the matrix, sensitive layer 22 demonstrates a very good response to carbon dioxide, since the speed of diffusion of CO₂ is very great because of the good gas permeability of the polymer. The usual addition of plasticizers is unnecessary.

The layer thickness of sensitive material 18 applied to the surface of particles 16 should not be greater than 20 μm, since otherwise sufficient diffusion of the gases to be determined, into the coating of particles 16, made of sensitive material 18, is not guaranteed.

Sensitive layer 22 is made in porous fashion in order to guarantee access of the gas mixture to as many areas of the layer as possible. An open-pored design of sensitive layer 22 is especially preferred, that means, that the gas spaces enclosed in the pores are in contact with one another in such a way that an almost unimpeded access on the part of the gas atmosphere to sensitive layer 22 is guaranteed. This is achieved when the proportion of sensitive material 18 does not exceed 25 volume% of sensitive layer 22.

The functioning of the sensitive layer 22 is based on its including a pH indicator and a base. The base effects a basic environment in sensitive layer 22 and converts the pH indicator into its deprotonated form. As soon as an acid gas, such as carbon dioxide comes into contact with sensitive layer 22, it reacts with water contained in the layer and forms hydrogen carbonates HCO₃−, as well as hydronium ions H₃O+. This reaction changes the pH value of the layer and leads to a reprotonating of the pH indicator, whereby sensitive layer 22 changes color. The color transition is detected via an absorption or transmission measurement upon choice of the appropriate wavelength ranges of radiation 13.

According to a second specific embodiment, not shown, sensitive layer 22 is not applied to substrate 14 but is applied directly to a detector. This simplifies the construction of the optical sensor.

The present invention is not limited to the exemplary embodiment described, but, depending on the application, further specific embodiments of the optical sensor, besides the one depicted in the FIGURE and described, are conceivable. Indeed, the determination of the most varied gases, having acid and also base reactions, is conceivable, such as CO₂, NOₓ, SO₂, SO₃, NH₃ or halogen hydrogen compounds. In addition, determination of CO or HCN is also possible with the use of an appropriately designed sensitive layer 22.

What is claimed is:

1. An optical gas sensor for determining a gas in a gas mixture, comprising:
a radiation source for emitting a radiation;
a substrate; and
a sensitive layer positioned on the substrate, wherein:
the sensitive layer is porous, and
the sensitive layer contains particles that are optically transparent to the radiation emitted from the radiation source and that lengthen an optical path of the radiation.

2. The optical gas sensor according to claim 1, wherein:
the optical gas sensor is for determining a gas component of air.

3. The optical gas sensor according to claim 1, wherein:
the particles include one of a glass, a quartz, and a PMMA.

4. The optical gas sensor according to claim 1, wherein:
each of the particles has a diameter of 3 to 20 μm.

5. The optical gas sensor according to claim 1, wherein:
the particles are hollow.

6. The optical gas sensor according to claim 1, wherein:
each of the particles is at least partially coated on a surface thereof with a material that is sensitive to the gas.

7. The optical gas sensor according to claim 6, wherein:
the material that is sensitive to the gas includes tetraoctylammonium hydroxide.

8. The optical gas sensor according to claim 6, the material that is sensitive to the gas includes polydiemthylsiloxane.

9. The optical gas sensor according to claim 6, the material that is sensitive to the gas is free of a plasticizer.

10. The optical gas sensor according to claim 6, wherein:
the sensitive layer includes gaps between the particles, and
the sensitive layer includes up to 25 volume% of the material that is sensitive to the gas.

11. The optical gas sensor according to claim 1, wherein:
the sensitive layer has a layer thickness of 20 to 100 μm.

12. The optical gas sensor according to claim 1, wherein:
the substrate includes a detector.

13. A method of using a sensor including a radiation source for emitting a radiation, a substrate, and a sensitive layer positioned on the substrate, the sensitive layer being porous, the sensitive layer containing particles that are optically transparent to the radiation emitted from the radiation source and that lengthen an optical path of the radiation, the method comprising the step of:
determining a presence of at least one of C0₂, NOₓ, SO₂, SO₃, NH₃, CO, HCN, and a halogen hydrogen compound.
